(19) United States
(12) Patent Application Publication
(10) Pub. No.: US 2013/0190006 A1
(43) Pub. Date: Jul. 25, 2013

(54) Methods and Systems for Enabling User Activity-Aware Positioning

(71) Applicants: Muhammad Kazmi, Bromma (SE); Iana Siomina, Solna (SE)

(72) Inventors: Muhammad Kazmi, Bromma (SE); Iana Siomina, Solna (SE)

(73) Assignee: TELEFONAKTIEBOLAGET L M ERICSSON (PUBL), Stockholm (SE)

(21) Appl. No.: 13/497,943

(22) PCT Filed: Jan. 20, 2012
(86) PCT No.: PCT/SE12/50050

§ 371 Date: Mar. 23, 2012

(51) Int. Cl. H04W 24/00

(52) U.S. Cl. 455/456.1

(57) ABSTRACT

Techniques for using user equipment, UE, activity information, e.g., by a network node in a communications network are described. The network node can obtain the UE activity information, i.e., information associated with at least one of transmission activity and reception activity for a UE, and then use the UE activity information to configure a positioning function. Some examples of the positioning function are positioning method selection, measurement configuration and assistance data provisioning, reserving positioning resources, stopping the positioning session, delaying handover of the UE, deciding on a position session organization such as number of parallel measurements to be performed, and estimating an impact on battery lifetime.

### TECHNICAL FIELD

The present invention relates generally to telecommunications systems, and in particular, to methods, systems, devices and software associated with positioning techniques in wireless communications networks.

### BACKGROUND

Radio communication networks were originally developed primarily to provide voice services over circuit-switched networks. The introduction of packet-switched bearers in, for example, the so-called 2.5G and 3G networks enabled network operators to provide data services as well as voice services. Eventually, network architectures will likely evolve toward all Internet Protocol (IP) networks which provide both voice and data services. However, network operators have a substantial investment in existing infrastructures and would, therefore, typically prefer to migrate gradually to all IP network architectures in order to allow them to extract sufficient value from their investment in existing infrastructures. Also to provide the capabilities needed to support next generation radio communication applications, while at the same time using legacy infrastructure, network operators could deploy hybrid networks wherein a next generation radio communication system is overlaid onto an existing circuit-switched or packet-switched network as a first step in the transition to an all IP-based network. Alternatively, a radio communication system can evolve from one generation to the next while still providing backward compatibility for legacy equipment.

One example of such an evolved network is based upon the Universal Mobile Telecommunications System (UMTS) which is an existing third generation (3G) radio communication system that is evolving into High Speed Packet Access (HSPA) technology. Yet another alternative is the introduction of a new air interface technology within the UMTS framework, e.g., the so-called Long Term Evolution (LTE) technology. Target performance goals for LTE systems include, for example, support for 200 active calls per 5 MHz cell and sub 5 ms latency for small IP packets. Each new generation, or partial generation, of mobile communication systems add complexity and abilities to mobile communication systems and this can be expected to continue with either enhancements to proposed systems or completely new systems in the future.

LTE uses orthogonal frequency division multiplexing (OFDM) in the downlink and discrete Fourier transform (DFT)-spread OFDM in the uplink. The basic LTE downlink physical resource can thus be seen as a time-frequency grid as illustrated in FIG. 1, where each resource element corresponds to one OFDM subcarrier during one OFDM symbol interval. In the time domain, LTE downlink transmissions are organized into radio frames of 10 ms, each radio frame consisting of ten equally-sized subframes of length T_{subframe}=1 ms as shown in FIG. 2.

Furthermore, the resource allocation in LTE is typically described in terms of resource blocks, where a resource block corresponds to one slot (0.5 ms) in the time domain and 12 contiguous subcarriers in the frequency domain. Resource blocks are numbered in the frequency domain, starting with 0 from one end of the system bandwidth. Downlink transmissions are dynamically scheduled, i.e., in each subframe the base station—typically referred to as an eNB in LTE—transmits control information indicating to which terminals and on which resource blocks the data is transmitted during the current downlink subframe. This control signaling is typically transmitted in the first 1, 2, 3 or 4 OFDM symbols in each subframe. A downlink signal with 3 OFDM symbols as the control region is illustrated in FIG. 3.

The possibility of identifying user geographical location in networks has enabled a large variety of commercial and non-commercial services, e.g., navigation assistance, social networking, location-aware advertising, emergency calls, etc. Different services may have different positioning accuracy requirements imposed by the application. In addition, some regulatory requirements on the positioning accuracy for basic emergency services exist in some countries, i.e. FCC E911 in US.

In many environments, the position of a user or user terminal (also referred to herein as “user equipment” or UE) can be accurately estimated by using positioning methods based on GPS (Global Positioning System). Nowadays networks have also often a possibility to assist UEs in order to improve the terminal receiver sensitivity and GPS start-up performance (Assisted-GPS positioning, or A-GPS). GPS or A-GPS receivers, however, may be not necessarily available in all wireless terminals. Furthermore, GPS is known to often fail in indoor environments and urban canyons. A complementary terrestrial positioning method, called Observed Time Difference of Arrival (OTDOA), has therefore been standardized by 3GPP. In addition to OTDOA, the LTE standard also specifies methods, procedures and signaling support for Enhanced Cell ID (E-CID) and A-GNSS. Later, UTDOA may also be standardized for LTE.

Three significant network elements in an LTE positioning architecture are the Location Services (LCS) Client, the LCS target and the LCS Server. The LCS Server is a physical or logical entity managing positioning for a LCS target device by collecting measurements and other location information, assisting the terminal in measurements when necessary, and estimating the LCS target location. A LCS Client is a software and/or hardware entity that interacts with a LCS Server for the purpose of obtaining location information for one or more LCS targets, i.e. the entities being positioned. LCS Clients may reside in a core network node, external clients, radio network node, UE, and the LCS targets themselves. An LCS Client sends a request to LCS Server to obtain location information, and LCS Server processes and serves the received requests and sends the positioning result and optionally a velocity estimate to the LCS Client. A positioning request can be originated from the terminal or the network.

Position calculation can be conducted, for example, by a positioning server (e.g. E-SMLC or SLP in LTE) or a UE. The former approach corresponds to the UE-assisted positioning mode, whilst the latter corresponds to the UE-based positioning mode. Two positioning protocols operating via the radio network exist in LTE, LPP and LPPa. The LPP is a point-to-point protocol between a LCS Server and a LCS target device, used in order to position the target device. LPP can be used both in the user and control plane, and multiple LPP procedures are allowed in series and/or in parallel thereby reducing latency. LPPa is a protocol between eNodeB and LCS Server specified only for control-plane positioning procedures, although it still can assist user-plane positioning by querying eNodeBs for information and eNodeB measurements. User plane positioning may use another protocol, e.g., SUPL. SUPL protocol is also used as a transport for LPP in the user plane. LPP has also a possibility to convey LPP extension messages inside LPP messages, e.g. currently OMA LPP extensions are being specified (LPPe) to allow e.g. for operator-specific assistance data or assistance data that cannot be provided with LPP or to support other position reporting formats or new positioning methods.

A high-level positioning architecture, as it is currently standardized in LTE, is illustrated in FIG. 4, where the LCS target is a terminal 400, and the LCS Server is an E-SMLC 402 or an SLP 404. In the figure, the control plane positioning protocols with E-SMLC 402 as the terminating point are shown as the three arrows labeled LCS-AP, LPPa, and LPP, disposed (at least in part) between the E-SMLC 402 and the MME 406, and the user plane positioning protocol is shown by the arrows labeled SUPL/LPP and SUPL. SLP 404 may comprise two components, SPC and SLC, which may also reside in different nodes. In an example implementation, SPC has a proprietary interface with E-SMLC 402, an Llp interface with SLC, and the SLC part of SLP 404 communicates with P-GW (PDN-Gateway) 408 and External LCS Client 410. Also seen in FIG. 4, are the radio access network (RAN) 412 including, e.g., an eNodeB 412. Additional positioning architecture elements may also be deployed to further enhance performance of specific positioning methods. For example, deploying radio beacons 416 and 418 is a cost-efficient solution which may significantly improve positioning performance indoors and also outdoors by allowing more accurate positioning, for example, with proximity location techniques.

To meet location based service (LBS) demands, the LTE network will deploy a range of complementing methods characterized by different performance in different environments. Depending on where the measurements are conducted and the final position is calculated, the methods can be UE-based, UE-assisted or network-based, each with own advantages. The following methods are available in the LTE standard for both the control plane and the user plane,
Cell ID (CID),
UE-assisted and network-based E-CID, including network-based angle of arrival (AoA),
UE-based and UE-assisted A-GNSS (including A-GPS),
UE-assisted Observed Time Difference of Arrival (OTDOA).
   Hybrid positioning, fingerprinting positioning and Ericsson method adaptive E-CID (AECID) do not require additional standardization and are therefore also possible with LTE. Furthermore, there may also be UE-based versions of the methods above, e.g. UE-based GNSS (e.g. GPS) or UE-based OTDOA, etc. There may also be some alternative positioning methods such as proximity based location. UTDOA may also be standardized in a later LTE release, since it is currently under discussion in 3GPP. LTE allows also, e.g., for positioning infrastructure enhancements, e.g., beacon technology which relies on deploying small radio devices, often called beacons. Similar methods, which may have different names, also exist in other RATs, e.g. WCDMA or GSM. Further, other methods may also be available via user-plane or LPP protocol enhancements such as LPPe. Some of these positioning techniques will now be discussed in more detail.

E-CID positioning exploits the advantage of low-complexity and fast positioning with CID which exploits the network knowledge of geographical areas associated with cell IDs, but enhances positioning further with more measurement types. With Enhanced Cell ID (E-CID), the following sources of position information are involved: the Cell Identification (CID) and the corresponding geographical description of the serving cell, the Timing Advance (TA) of the serving cell, and the CIDs and the corresponding signal measurements of the cells (up to 32 cells in LTE, including the serving cell), as well as AoA measurements. The following UE measurements can be utilized for E-CID in LTE: E-UTRA carrier Received Signal Strength Indicator (RSSI), Reference Signal Received Power (RSRP), Reference Signal Received Quality (RSRQ), and UE Rx-Tx time difference. The E-UTRAN measurements available for E-CID are eNodeB Rx-Tx time difference (also called TA Type 2), TA Type 1 being (eNodeB Rx-Tx time difference)+(UE Rx-Tx time difference), and UL AoA, UE Rx-Tx measurements are typically used for the serving cell, whilst e.g. RSRP and RSRQ as well AoA can be utilized for any cell and can also be conducted on a frequency different from that of the serving cell.

E-CID measurements are typically performed on cell-specific reference signals (CRS), which is, however, not strictly mandated. But the UE requirements are derived under the assumption that UE uses CRS. Hence in practice the UE is most likely to utilize the CRS for performing the E-CID measurements.

UE E-CID measurements are reported by the UE to the positioning server (e.g. Evolved SMLC, or E-SMLC, or SUPL Location Platform, or SLP, in LTE) over the LTE Positioning Protocol (LPP), and the E-UTRAN E-CID measurements are reported by the eNodeB to the positioning node over the LPP Annex protocol (LPPa). The UE may receive assistance data from the network

UE may receive assistance data from the network e.g. via LPPe (no LPP assistance for E-CID is currently specified in the standard, however, it may be sent via LPP extension protocol, LPPe).

The OTDOA positioning method makes use of the measured timing of downlink signals received from multiple eNodeBs at the UE. The UE measures the timing of the received signals using assistance data received from the LCS server, and the resulting measurements are used to locate the UE in relation to the neighbouring eNodeBs.

With OTDOA, a terminal measures the timing differences for downlink reference signals received from multiple distinct locations. For each (measured) neighbor cell, the UE measures Reference Signal Time Difference (RSTD) which is the relative timing difference between neighbor cell and the reference cell. The UE position estimate is then found as the intersection of hyperbolas corresponding to the measured RSTDs. At least three measurements from geographically dispersed base stations with a good geometry are needed to solve for two coordinates of the terminal and the receiver clock bias. In order to solve for position, precise knowledge of the transmitter locations and transmit timing offset is needed

To enable positioning in LTE and facilitate positioning measurements of a proper quality and for a sufficient number of distinct locations, new physical signals dedicated for positioning (positioning reference signals, or PRS) have been introduced and low-interference positioning subframes have been specified in 3GPP. PRS are transmitted from one antenna port (R6) according to a pre-defined pattern which is described in the standards document 3GPP TS 36.211, Section 6.10 Version 10.4.0, December 2011. A frequency shift, which is a function of Physical Cell Identity (PCI), can be applied to the specified PRS patterns to generate orthogonal patterns and modeling the effective frequency reuse of six, which makes it possible to significantly reduce neighbour cell interference on the measured PRS and thus improve positioning measurements. PRS are transmitted in pre-defined positioning subframes grouped by several consecutive subframes (N_{PRS}), i.e. one positioning occasion. Positioning occasions occur periodically with one of the pre-defined periods of N subframes, i.e. the time interval between two positioning occasions. PRS may also be muted, e.g., not transmitted or transmitted with a lower power.

Even though PRS have been specifically designed for positioning measurements and in general are characterized by better signal quality than other reference signals, the standard does not mandate using PRS. Other reference signals, e.g. physical signals or cell-specific reference signals (CRS) could in principle also be used for positioning measurements.

An important aspect of packet transmission in radio communication systems is discontinuous transmission (DTX) and discontinuous reception (DRX). The E-UTRAN is primarily a packet oriented system without any circuit switch transmission. This means E-UTRAN can easily be optimized for packet transmission. In E-UTRAN, DRX is used in both idle and RRC connected modes. The positioning measurements are typically done in connected mode. Furthermore in E-UTRAN, wide range of DRX cycles for use in the RRC connected mode is allowed by the network; the DRX can vary between 2 ms to 2.56 seconds.

Discontinuous transmission (DTX), such as discontinuous power control and use of idle gaps for measurements, may also affect the positioning performance. DTX is characterized by periodic pattern of activity or transmission followed by relatively longer inactivity or idle periods. In UTRAN, the discontinuous transmission is characterized by discontinuous power control channel (DPCCH) and is used to reduce the interference and UE power. Similarly other idle gaps such as compressed mode gaps and measurement gaps are used in UTRAN and E-UTRAN respectively. In E-UTRAN the DTX state also occurs due to packet oriented transmission and semi persistence scheduling.

A number of positioning measurements, and in particular the E-CID measurements, rely on the CRS or other signals which are transmitted by the eNode B or by the UE in every subframe. When restricted measurement subframes are allowed for measurements, the positioning measurement requirements will be affected. For example the UE Rx-tx time difference measurement depends upon the CRS for the estimation of the DL received frame timing. Thus when eICIC TDM pattern is configured the limited DL subframes available for the measurements will affect the UE Rx-Tx time difference measurement requirements in a manner similar to RSRP/RSRQ requirements. This means the L1 measurement period will have to be extended for E-CID measurements when restricted subframes are used for obtaining the measurement samples.

Similarly the UE Rx-tx time difference measurement requirements also depend upon the DRX in use. For example, the measurement period (Tₘₑₐₛᵤᵣₑ_{_{—}}_{FDD}_{_{—}}_{UE}_{_{—}}_{Rx}_{_{—}}_{Tx}) increases with the length of the DRX cycle as shown in table 1.

TABLE 1
UE Rx-tx time difference measurement period

| | Tₘₑₐₛᵤᵣₑ_{_{—}}_{FDD}_{_{—}}_{UE}_{_{—}}_{Rx}_{_{—}}_{Tx} (s) |
|---|---|
| DRX cycle length (s) | (DRX cycles) |
| ≦0.04 | 0.2 (Note1) |
| 0.04 < DRX-cycle ≦ 2.56 | Note2 (5) |

(Note1): Number of DRX cycle depends upon the DRX cycle in use
Note2: Time depends upon the DRX cycle in use

The LTE specification provides for both Frequency Division Duplex (FDD) and Time Division Duplex (TDD) operation modes. Additionally, a half duplex operation is also specified, which is essentially the same as the FDD operation mode but with transmissions and receptions not occurring simultaneously (as in TDD). Half duplex mode has some advantages with in certain frequency arrangements where the duplex filter my be difficult to implement, resulting in high cost and high power consumption. Since the carrier frequency number (EARFCN) is unique, by knowing the carrier frequency number it is possible to determine the frequency band, which is either an FDD band or a TDD band. However, it may be more difficult to find the difference between full duplex FDD and half-duplex FDD (HD-FDD) without explicit information since the same FDD band can be used as either full FDD or HD-FDD.

In LTE the OTDOA and E-CID positioning measurements and their corresponding requirements are specified for both FDD and TDD. For TDD, the same RSTD measurement definition, the same methods and the same accuracy requirements shall apply as for FDD, with the exception that, for TDD, the intra-frequency and inter-frequency RSTD measurement requirements are applicable for selected uplink-downlink sub-frame configurations. For half duplex FDD, the measurement period or reporting delay for certain positioning measurements may have to be extended or the requirements may have to be made applicable to certain half duplex configuration (i.e. when a certain number of DL and/or UL sub-frames are available).

Positioning in wireless networks is challenging due to users' mobility as well as the dynamic nature of the environment and radio signals. Positioning performance is typically described in terms of accuracy, confidence level, and the time necessary for obtaining the positioning result, i.e., the three main characteristics associated with positioning QoS. Different services may have different positioning accuracy requirements imposed by the application, typically implying that a variety of positioning methods are available in the network. Different positioning methods also exploit different technologies and thus may also have different requirements. In addition, some regulatory requirements for positioning accuracy for basic emergency services exist in some countries, i.e. FCC E911 in US.

To achieve the desired positioning accuracy, it is necessary to ensure that the measurements used for positioning also meet certain minimum requirements. This is because different receiver implementations, even implementing the same standard, may perform differently under the same conditions. Typically, accuracy and reporting delay requirements are defined for positioning measurements. For example, UE Rx-Tx time difference measurements for E-CID and RSTD measurements for OTDOA in LTE. Further, the requirements may be specified for FDD and TDD, intra-frequency and inter-frequency, DRX and non-DRX states. In LTE, it is common to specify generic requirements when possible, e.g., the accuracy requirements for UE Rx-Tx and RSTD measurements are the same for FDD and TDD, DRX and non-DRX states. However, UE inactivity periods used, e.g., for energy saving reasons, may impact at least the measurement reporting delay. Thus, different reporting delay requirements have been defined for UE Rx-Tx. For RSTD, all current requirements are the same for DRX and non-DRX due to positioning occasions being configured relatively sparsely in time, e.g., a minimum 160 ms between two consecutive positioning occasions.

No requirements are specified yet for UL measurements used for positioning, e.g., for UTDOA or E-CID. There are currently no requirements which account for the reduced measurements occasions e.g. due to introducing restricted measurement patterns such as those enabling eICIC, where the patterns restrict the UE measurements, such as RRM, RLM, or CSI, to certain subframes. RRM measurements are performed on CRS and thus intuitively the same restrictions shall apply also to other measurements based on CRS, e.g., UE Rx-Tx time difference measurements or CRS-based RSTD measurements.

With multiple positioning methods available, a positioning node has to select the method or a sequence of positioning methods that best meet the requested positioning QoS (e.g., accuracy, confidence level, and response time) typically received in a positioning request. These parameters are typically service- and/or client-dependent. Further, the positioning node may have UE capability information, e.g., supported positioning methods [3GPP TS 36.355] or UE radio access capabilities such as supported E-UTRAN frequencies [3GPP TS 36.355]. From the selected set of methods supported by the network and UE, the positioning node typically selects the method that first meets the response time criterion and then the accuracy criterion, checked in a sequential way.

### Abbreviations/Acronyms

3GPP 3^{rd} Generation Partnership Project
A-GPS Assisted GPS
BS Base Station
CRS Cell-specific Reference Signal
DRX Discontinuous Reception
DTX Discontinuous Transmission
EMGRI Enhanced measurement gap-related information
eNodeB evolved Node B
E-SMLC Evolved SMLC
GPS Global Positioning System
LPP LTE Positioning Protocol
LPPa LPP Annex
LBS Location-Based Service
LCS Location Services
LTE Long-Term Evolution
OMA Open Mobile Alliance
OTDOA Observed Time Difference Of Arrival
PCI Positioning Reference Signal
RB Resource Block
RE Resource Element
RRC Radio Resource Control
RS Reference Signal
SFN System Frame Number
SINR Signal-to-Interference Ratio
SMLC Serving Mobile Location Center
UE User Equipment
UMTS Universal Mobile Telecommunications System

### SUMMARY

Positioning method performance depends on a number of factors, among which are: (a) UE activity (e.g., IDLE or CONNECTED state, DRX or non-DRX, DTX, etc.), and (b) the measurement configuration being used. By providing the relevant positioning nodes with information about, e.g., UE activity (level), positioning performance can be improved.

According to an embodiment, a method for using user equipment activity information by a network node in a communications network includes obtaining the UE activity information which indicates a pattern of at least one of transmission activity and reception activity for a UE. Then, the obtained UE activity information can be used to perform at least one of: (a) estimating at least one of an expected response time and a positioning quality associated with each of a plurality of positioning methods that can be selected for determining a position of the UE, (b) selecting a positioning method to determine a position for the UE, (c) adaptive enhanced cell identification, AECID, and (d) fingerprinting positioning of the UE.

According to another embodiment, a network node can be configured to perform the foregoing method. For example, the network node can include a processor configured to obtain user equipment, UE, activity information, wherein the UE activity information is associated with at least one of transmission activity and reception activity for a UE. The processor can further be configured to use the obtained UE activity information to perform at least one of: (a) estimating at least one of an expected response time and a positioning quality associated with each of a plurality of positioning methods that can be selected for determining a position of the UE, (b) selecting a positioning method to determine a position for the UE, (c) adaptive enhanced cell identification, AECID, and (d) fingerprinting positioning of the UE.

According to still another embodiment a device, e.g., a user equipment or a network node can be configured to transmit information associated with the UE's activity level, e.g., to be used for one of the above-stated functions. Such a device can include a transceiver configured to transmit a message which includes information associated with a user equipment's, UE's, activity level, wherein the UE's activity level information indicates a pattern of at least one of transmission and reception activity by the UE.

### BRIEF DESCRIPTION OF THE DRAWINGS

The exemplary embodiments described below will be understood, in conjunction with the drawings submitted herewith in which:

FIG. 1 represents an LTE OFDM downlink signal in the frequency/time domain;

FIG. 2 shows a subframe associated with an LTE OFDM signal in the time domain;

FIG. 3 illustrates a downlink signal with 3 OFDM symbols as the control region;

FIG. 4 depicts an LTE positioning architecture in which embodiments can be implemented;

FIG. 5 illustrates an exemplary radio communication system in which embodiments can be implemented;

FIG. 6 shows transmit chain and a receive chain associated with elements of the radio communication system of FIG. 5;

FIG. 7 depicts a generic node in which embodiments can be implemented;

FIG. 8 is a flowchart illustrating a method for using UE activity level information according to an embodiment; and

FIG. 9 depicts a transmission/reception scheme associated with testing according to an embodiment.

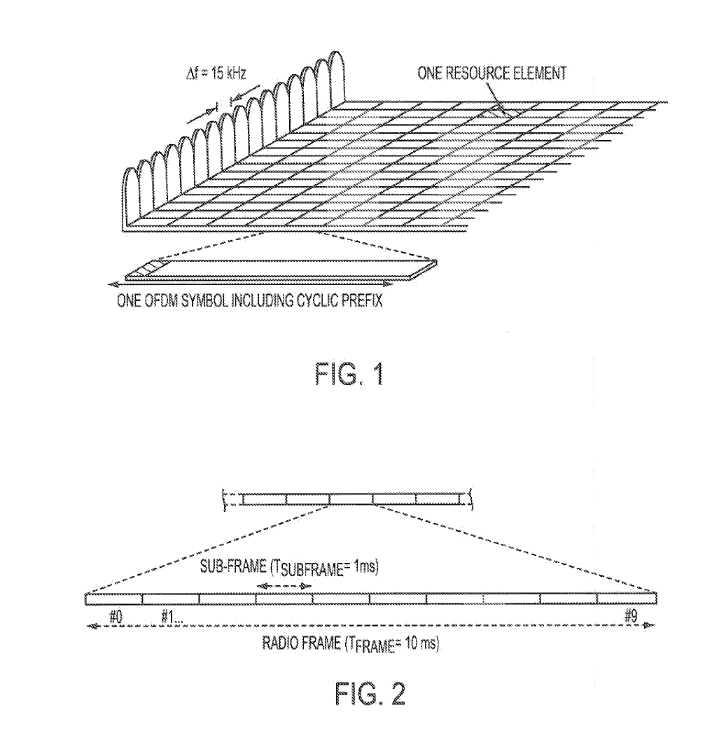

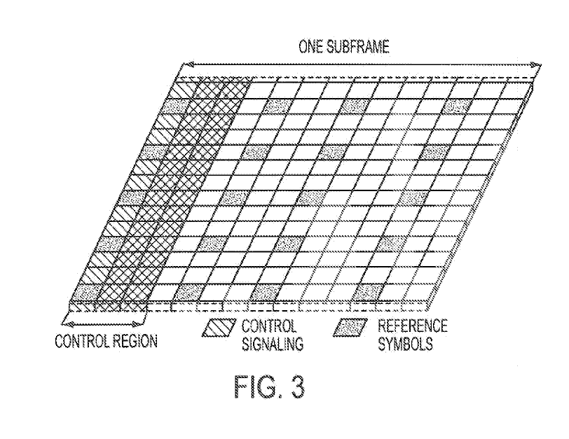

### DETAILED DESCRIPTION

The following detailed description of the exemplary embodiments refers to the accompanying drawings. The same reference numbers in different drawings identify the same or similar elements. Also, the following detailed description does not limit the invention. The following embodiments are discussed, for simplicity, with regard to the terminology and structure of LTE systems. However, the embodiments to be discussed next are not limited to LTE or LTE-Advanced systems but may be applied to other telecommunications systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

From the Background described above, it will be appreciated that positioning method performance depends on a number of factors, among which are: (a) UE activity (e.g., IDLE or CONNECTED state, DRX or non-DRX, DTX, etc.), and (b) measurement configuration such as restricted measurement pattern indicating e.g. the density of measurement occasions for positioning measurements (e.g., for CRS-based UE Rx-Tx time difference measurements or CRS-based OTDOA positioning). These, among other complexities associated with positioning in LTE systems create a number of problems, described in detail below, for which it would be desirable to generate solutions.

Problem 1: This information described in the preceding paragraph is currently not available to the positioning node and thus cannot be exploited to enhance positioning performance, e.g., for positioning method selection. For example, information associated with, e.g., DRX configuration and/or power saving operation, subframes configured for measurements in heterogeneous networks, and UL/DL configuration, is not currently available at the positioning node for use in, e.g., positioning method selection. No mechanism is available to deliver this type of information to the positioning node.

Problem 2: At least some of the current positioning measurement requirements (e.g., minimum measurement requirements for UE Rx-Tx time difference, see e.g. Table 8.1.2.7.1-1 in 3GPP TS 36.133, Section 8.1.2.7.1) depend on DRX, which will impact the E-CID positioning response time if a UE is in DRX. However, the positioning node is not aware of whether the UE being positioned is in DRX or not, which may result in a wrong method selection decision.

Problem 3: Restricting UE measurements, e.g., by configuring restricted measurement patterns such as being standardized for eICIC, will also impact positioning measurements, e.g., CRS-based UE Rx-Tx time difference measurements, since fewer measurement occasions are available, so either the measurement time needs to be increased or the accuracy requirement relaxed. In either case, new requirements need to be defined. The requirements will be different from those without restricted measurements. This means that different positioning performance shall be expected with and without restricted measurement occasions. So, similar to the Problem 2, to know, e.g., whether the response time criterion is met when selecting the positioning method, the positioning node needs to know whether restricted measurements apply for the UE as well as the restricted measurement pattern. Currently, there are no means to make this information available for the positioning node and there are no positioning requirements that make positioning measurements possible when restricted measurements apply.

Problem 4: There are positioning measurements for which the same measurement requirements apply for DRX and non-DRX, e.g., RSTD measurements for OTDOA. However, it is a requirement on the OTDOA assistance data that there must be at least one cell in the OTDOA assistance data for which either the cell timing information (e.g., SFN) is known to the UE or the UE can obtain this information. The UE typically knows the SFN of the serving cell. If the SFN of a cell is not known to the UE, then the UE needs to read the broadcast information for which it may also need to do cell search. The cell search requirements are different for non-DRX and DRX states and also depend on the DRX cycle, e.g., when UE DRX is 1.28 second the time required to search the cell when SCH Ês/Iot≧−4 dB is about 1.28 second*20=25.6 seconds. For UE DRX cycle=2.56 seconds the cell search time is 20*2.56 s=51.6 seconds. Hence, to correctly estimate the expected OTDOA QoS parameters when selecting positioning methods, the positioning node needs to know whether the UE is in DRX or not and also the DRX cycle if it is, and with the current standard the positioning node lacks this information.

Problem 5: The performance statistics of various positioning methods, including response time and accuracy, is currently collected, stored and used without taking into account the information about UE activity periods and whether restricted measurements were used during the obtained positioning result, which may lead to erroneous positioning method selection, if it is based on this information, and wrong interpretation of the positioning method performance.

These, and other problems and drawbacks associated with implementation of positioning methods in radio communication systems such as LTE are addressed by embodiments. Such embodiments include, for example, methods and devices for determining UE activity, where the device may, e.g., be a control-plane or user-plane positioning node or test equipment, signaling methods and structures for enabling the UE activity information in the network node, methods and network nodes for using the UE activity information for positioning, e.g., for method selection or estimating the expected response time for a positioning method, methods and network nodes for using the UE activity information in the network node, which may also be a test equipment, for determining the time before the UE can start positioning measurements and/or sending the assistance data while accounting for the determined time (the time may also be pre-configured in the network node), methods and network nodes for using the UE activity information for AECID or fingerprinting, e.g., using the UE activity information for tagging other positioning or RF measurements, e.g., for AECID or fingerprinting positioning, using the UE activity information as a fingerprint or a “measurement” for AECID or fingerprinting, and/or maintaining the UE activity information in AECID or fingerprinting databases.

Prior to discussing such embodiments in detail, some caveats and terminologies used in these embodiments are provided. Although the description is mainly given for UE, it should be understood by those skilled in the art that “UE” is a non-limiting term which means any wireless device or node (e.g. PDA, laptop, mobile, sensor, fixed relay, mobile relay or even a small base station or any device that is being positioned when timing measurements for positioning are considered, drive test UE, or a LCS target in general). The invention applies, for example, both for UEs capable and not capable of performing inter-frequency measurements without gaps, e.g. also including UEs capable of carrier aggregation.

Similarly, “radio node”, “base station” or “eNodeB”, which terms are used interchangeably herein, comprise any node transmitting or receiving radio signals that may be used for positioning, measurements, e.g., eNodeB, macro/micro/pico base station, home eNodeB, relay, beacon device, radio measurement unit, or repeater. Furthermore, in at least in some embodiments a radio node may be test equipment or a system simulator (SS) with a radio interface acting as or emulating a radio node in a test.

The term “positioning node” described in different embodiments is a node with positioning functionality. For example, for LTE it may be understood as a positioning platform in the user plane (e.g., SLP in LTE) or a positioning node in the control plane (e.g., E-SMLC in LTE). SLP may also consist of SLC and SPC, where SPC may also have a proprietary interface with E-SMLC. Furthermore, at least in some embodiments a positioning node may be test equipment or a system simulator (SS) acting as or emulating a positioning node, e.g., delivering positioning assistance data, in a test.

The signaling described herein is either via direct links or logical links (e.g. via higher layer protocols and/or via one or more network nodes). For example, in LTE in the case of signaling between E-SMLC and LCS Client the positioning result may be transferred via multiple nodes (at least via MME and GMLC). The embodiments are not limited to the currently standardized positioning methods such as OTDOA, E-CID or UTDOA, measurements such RSTD, UE Rx-Tx time difference or TOA, or RATs such as LTE. The embodiments may apply for any method, measurement type, or RAT when measurement gaps are to be configured for performing positioning measurements. The invention is not limited to control-plane positioning or user-plane positioning.

The term “positioning function” is used herein generically to refer to various functions associated with positioning. Some non-limiting examples of the positioning function are positioning method selection, measurement configuration and assistance data provisioning, reserving positioning resources, stopping the positioning session, delaying handover of the UE, and deciding on a position session organization such as number of parallel measurements to be performed, and estimating an impact on battery lifetime.

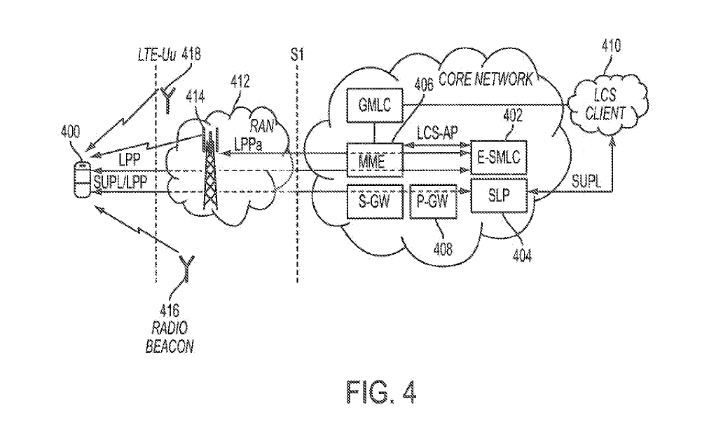

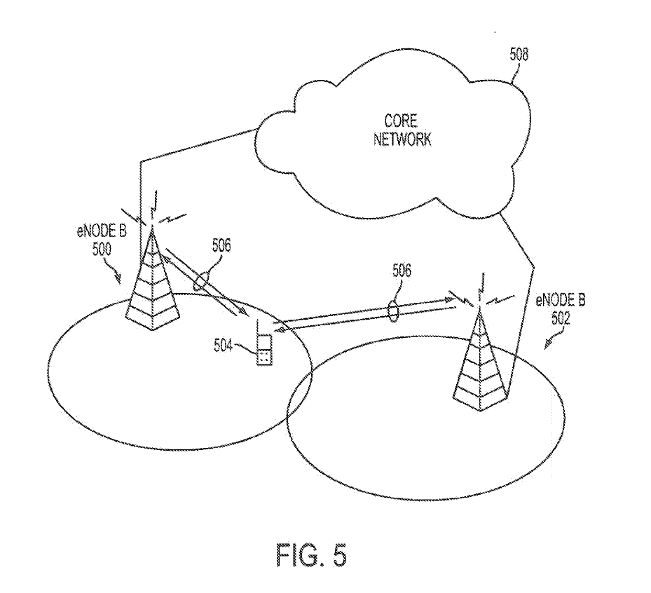

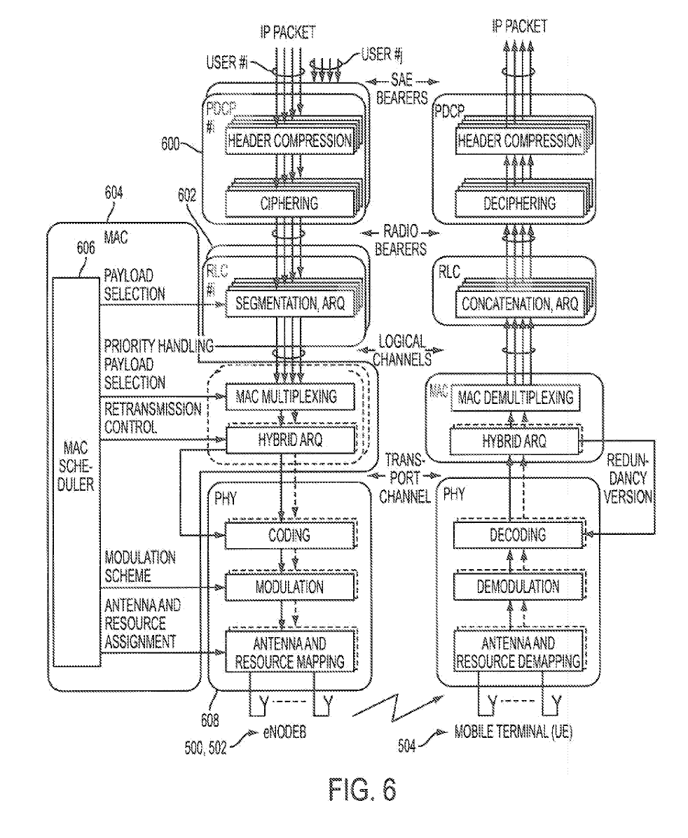

To provide some further context, e.g., in addition to that described above with respect to FIG. 4, for positioning-related embodiments described in more detail below, consider the exemplary radio communication system as shown from two different perspectives in FIGS. 5 and 6, respectively.

An eNodeB in an LTE system handles transmission and reception in one or several cells, as shown for example in FIG. 5. FIG. 5 shows, among other things, two eNodeBs 500, 502 (and their corresponding cells) and one user terminal or UE 504. The user terminal 504 uses uplink and downlink channels 506 to communicate with the eNodeB(s) 500, 502, e.g., by transmitting or receiving RLC PDU segments as described below. The two eNodeBs 500, 502 are connected to a Core Network 508. In the context of this specification, it may be desirable to determine the position of the UE 504 using techniques described below.

One exemplary LTE architecture for processing data for transmission by an eNodeB 500, 502 to a UE 504, i.e., in the downlink (DL) is shown in FIG. 6. Therein, data to be transmitted by the eNodeB 500, 502, e.g., IP packets, to a particular user is first processed by a packet data convergence protocol (PDCP) entity 600 in which the IP headers can be compressed and ciphering of the data is performed. The radio link control (RLC) entity 602 handles, among other things, segmentation of—and/or concatenation of—the data received from the PDCP entity 600 into protocol data units (PDUs). Additionally, the RLC entity 602 provides a retransmission protocol, e.g., automatic repeat request (ARQ), which monitors sequence number status reports from its counterpart RLC entity in the UE 504 to selectively retransmit PDUs as requested.

The medium access control (MAC) entity 604 is responsible for uplink and downlink scheduling via scheduler 606, as well as hybrid-ARQ processes. A physical (PHY) layer entity 608 takes care of coding, modulation, and multi-antenna mapping, among other things. Each entity 600-608 shown in FIG. 6 provides outputs to, and receives inputs from, their adjacent entities by way of bearers or channels as shown. The reverse of these processes are provided for the UE 504 as shown in the right hand side of FIG. 6 for the received data, and it will be appreciated by those skilled in the art that, although not shown in FIG. 6, the UE 504 also has similar transmit chain elements as the eNB 500, 502 for transmitting on the uplink (UL) toward the eNB 500, 502 and the eNB 500, 502 also has similar receive chain elements as the UE 504 for receiving data from the UE 504 on the UL.

Having described some exemplary LTE devices in which aspects of positioning according to embodiments can be implemented, the discussion now returns to such positioning-related mitigation embodiments. According to embodiments, UE activity information is determined and then used in positioning. UE activity information in a general sense comprises the information related to UE transmitting and/or receiving activity. The UE activity information may, according to embodiments, e.g., be any combination of:
DRX and/or DTX indication, e.g., yes/no,
DRX and/or DTX configuration (e.g., DRX cycle),
Type of duplex mode of operation e.g. FDD, TDD, half duplex FDD, multi-duplex mode, etc
   UL/DL and special subframe configurations in case of TDD
   Minimum UL and DL subframes in a frame for half duplex FDD
Restricted measurement configuration (e.g., pattern for CSI, RRM or RLM measurements),
UE transmitting/receiving pattern over multiple carriers in a multi-carrier system (e.g., multi-carrier DL and/or UL scheduling information which may be a pattern of persistent or semi-persistent resource allocations across carriers),
More general UE activity information, e.g. any pattern describing periodicity and the allocations of UE transmission and/or receiving activity,
The portion of time spent by the UE in activity or inactivity state(s) during the positioning session or measurements.
Measurement cycle used (i.e. configured by the network) for performing measurement on secondary cells (aka secondary carriers) in carrier aggregation and more specifically for deactivated secondary carriers or cells
   Different types of activity information may be used for different positioning methods, e.g., DRX information may be used for E-CID, DTX information may be for UTDOA, restricted measurement pattern information may be for E-CID, OTDOA, AECID, etc.

According to embodiments, methods and devices are described for determining UE activity, where the device may, e.g., be control-plane or user-plane positioning node or test equipment. Such methods and devices include, for example, methods and devices by which the network node determines the UE activity autonomously, and methods and devices by which the network node receives or acquires the explicit UE activity information.

According to an embodiment, the network node may determine the UE activity autonomously, i.e., without receiving any explicit information about the UE activity. This may be implemented, e.g., by either extracting or deducing this information from other information and/or measurements available in the network, where the information and/or measurements may be related to this particular UE or other UEs. For example, the network node may receive periodic measurement reports that may reflect the UE activity, e.g., larger reporting interval may be used for less active UEs. The network node may, e.g., determine the reporting rate, which may be useful when the measurement reporting has been configured by other node, e.g., radio node or SON or MDT, but the network node receives measurement reports from either UE or radio node. The network node may also maintain the pre-determined information about the expected reporting rates in different activity states, and the identify the likely UE activity state by comparing the UE reporting rate to the set of pre-determined values (or a reference value) and the corresponding states. The pre-determined value or a reference value may correspond to a state with full activity (e.g. non-DRX, non-DRX, no restriction of subframes for measurements etc). The network node can thus determine the level of activity by observing the deviation between the reported measurements results and the pre-determined/reference values.

In another example, the network node may conclude about activity from the set of received measurement, when not all measurements are available in all activity states or configurations. It may also be so that only event-triggered reporting may be allowed in some states. The network node may also be aware about the triggering source or functionality which may also preclude or, the other way around, may imply certain states. Further, the network node may collect the measurement statistics for the given UE (e.g., during MDT) and conclude about the UE behavior by comparing the reported measurements and the reporting intensity at different time intervals. For example, the measurement reporting delay increases proportionally with the increase in the DRX cycle length.

The positioning node typically also collects measurement statistics and positioning results for different UEs. Different UEs may, however, show similar behavior in similar environments, so the network node may conclude about typical UE behavior and/or activity pattern, e.g., in certain conditions or certain environments or at certain time (of the day, of the week, etc.). Activity information may be pre-determined in the network node for certain states, services and/or client types, e.g., no DRX for emergency calls.

According to embodiments, the UE activity information may be provided to the network node (e.g., positioning node) by another node, e.g., radio node via LPPa, SON, MDT, etc, where the radio node may be associated with the serving/primary cell of the UE, or the UE via a higher-layer protocol, e.g., LPP or its enhancements such as LPPe. The activity information may be provided upon a request from the network node or in an unsolicited way.

The UE activity information may be provided in a positioning request, e.g., received by the network node from the UE or LCS Client. In one embodiment, the information may be provided together with the serving/primary carrier information. In another embodiment, the activity information may be provided prior or during, e.g., in the beginning of, a positioning session. The activity information may also be provided by the UE or radio node together with the positioning measurements, e.g., the activity state configuration (may be a coded value) in the beginning of the measurements or in the end of measurements or most of the time during measurements. This information may be useful e.g. for building up AECID or fingerprinting databases.

According to embodiments, methods and devices for using the UE activity information, e.g., as described above, for positioning are described as non-limiting examples that comprise the following use cases: estimating the expected response time and/or positioning quality, positioning method selection adaptive to the UE activity information, determining the time before the UE can start positioning measurements, using the activity information for AECID or fingerprinting.

The response time and the positioning quality for a UE may need to be estimated for multiple purposes, e.g.: (a) estimating the length of a positioning session, e.g., for reserving positioning resources, or stopping the session when no report is received within the estimated time plus some margin, or delaying handover or carrier switching decisions to let the positioning measurements complete (for example, for emergency positioning), or deciding on positioning session organization, e.g., the session may involve a series of measurement sessions or a number of parallel measurement sessions, not necessarily for the same positioning method, or estimating the impact on the battery time, e.g., by estimating for how long the UE needs to stay in the CONNECTED mode instead of going to the IDLE mode; (b) estimating the measurement and position quality, e.g., knowing the typical or maximum measurement time, which embodiment relates to obtaining the quality characteristic for the received measurements; for example, the estimated position quality may, e.g., be further compared to the target quality value and determine whether another positioning method may need to be attempted; (c) predicting positioning performance for a UE for a positioning method which may be used for positioning method selection, in which embodiment, it is proposed that the statistics is collected and processed while accounting for UE activity states, e.g., being processed separately and thus giving different predicted quality for different activity states for the same UE and the same method. This approach may significantly improve selection of the positioning method in the first attempt, when a limited set of information about the UE location is available, and thus the statistical positioning method performance may be very useful. The predicted positioning method quality for a UE, based on the statistics in the area, will then be determined based on the available activity information.

The expected response time may be pre-configured for a given activity state or may be dynamically estimated using the activity information, e.g., by dividing the typical measurement period without measurement restriction patterns by the activity factor or blanking rate which indicated a portion of time available for measurements. The pre-configured values may correspond e.g. to the standardized measurement reporting requirements, which may differ e.g. for DRX and non-DRX and may also be different for different DRX cycles. The same approach may also be used e.g. for restricted measurement patterns, if the new requirements are to be introduced for eICIC.

According to an embodiment, the UE activity information is used to enhance positioning method selection. For example, the response time and the accuracy may be estimated for a set of candidate methods while using the activity information. For example, when DRX is used, the RSTD measurement reporting delay may be not impacted whilst the E-CID measurement reporting delay may significantly increase, depending on the DRX cycle, which may make OTDOA into a faster positioning method than E-CID for a given activity state.

For each activity state, there may be a pre-determined positioning method that the positioning node is likely to select or a sequence of several positioning methods in the order of priorities. The corresponding method or the sequence of methods may be selected for a UE, when the activity information is available. Thus, a list of choices may be configured in the positioning node, where each choice is associated with an activity state.

When the activity information is not available, the choice may be pre-determined or configured for some default activity state, e.g., no DRX or low DRX. The default configuration may also depend on whether the UE is served by pico or macro node, e.g., in some network deployments and environments UEs may be expected to use restricted measurement patterns when they are served by pico UEs, which would imply longer measurement period for some positioning measurements (e.g., E-CID UE Rx-Tx). Another example is macro-femto deployments, where a macro UE may use restricted measurement pattern on subframes protected from high DL interference from femto cell, whilst femto UE would probably not need to use such patterns, which implies different expected response time for the same method for the two different UEs.

In another embodiment, when the activity information is not available, method selection may be decided based on the method performance evaluation assuming the worst-case activity state (e.g., the longest DRX). Alternatively, method selection may be used on the available UE activity statistics collected over multiple UEs, e.g., in a given environment or given cell.

In another embodiment, for detecting the timing information, some UEs, also depending on the information provided to the UE by the network, may not need to perform the cell search procedure but still may need to read the broadcast channel. Acquiring the timing information may be avoided if, e.g., the SFN of all neighbors is the same as for the serving cell, or this information is provided to the UE, e.g., by explicit signaling, which may be including in the assistance data the SFN of the reference cell or the SFN offset with respect to the serving cell is provided in the assistance data.

In yet another embodiment, the test environment may be configured by another device or program, e.g., simulator. Further, an event of the delivery of the activity information to the device/program acting as a positioning node in the test may also be implemented.

Embodiments can also provide for test specifications associated with RSTD measurement reporting delay, e.g., an E-UTRAN FDD-FDD inter-frequency RSTD measurement reporting delay test case with the reference cell on a non-serving carrier frequency. The purpose of the test is to verify that the FDD-FDD inter-frequency RSTD measurement reporting delay meets the requirements specified in 3GPP TS 36.133 Section 8.1.2.6.1, specifically for Note 1 in Table 8.1.2.6.1-1, in an environment with fading propagation conditions.

In order to describe the above embodiment related to testing an exemplary test case is provided. In the test there are four cells: Cell 1, Cell 2, Cell 3, and Cell 4. Cell 1 is the reference. Cell 2 and Cell 3 are the neighbour cells. Cell 1, Cell 2, and Cell 3 are synchronous cells on a FDD RF channel 2. Cell 4 is the serving cell on FDD RF channel 1. The UE requires measurement gaps to perform inter-frequency measurements. Gap pattern configuration #0 as defined in Table 8.1.2.1-1 is provided and configured to not overlap with PRS subframes of Cell 4.

The test consists of three consecutive time intervals, with duration of T1, T2 and T3. Cell 1 and Cell 4 are active in T1, T2 and T3, whilst Cell 2 and Cell 3 are activated only in the beginning of T2. Cell 2 is active until the end of T3, and Cell 3 is active until the end of T2. The beginning of the time interval T2 shall be aligned with the first PRS positioning subframe of a positioning occasion in the Cell 1, where the PRS positioning occasion is as defined in Section 8.1.2.5.1. Cell 1 and Cell 3 transmit PRS only in T2. Cell 2 transmits PRS only in T3. Cell 4 transmits PRS in T2 and T3. Note: The information on when PRS is indicated as muted is conveyed to the UE using PRS muting information.

The OTDOA assistance data as defined in TS 36.355, Section 6.5.1, shall be provided to the UE during T1. The last TTI containing the OTDOA assistance data shall be provided to the UE ΔT=ΔT1+ΔT2 ms before the start of T2, where ΔT1=150 ms is the maximum processing time of the OTDOA assistance data and ΔT2=4000 ms is the maximum time required by the UE to acquire the timing information of the reference cell.

Prior to the start of the time period T2 the UE shall not have any timing information of Cell 1, Cell 2 and Cell 3. The UE is in DRX from the beginning of T1, and stay in DRX in T2 and T3. The eNodeB reconfigures DRX (to a shorter DRX or non-DRX) upon receiving inter-frequency measurement gap request and reconfigures it back after time ΔT (determined by the network) to enable acquiring the timing of the reference cell in the OTDOA assistance data, which timing may not be available and thus cell search for the reference cell by the UE may be needed. Cell search in long DRX may be too long for positioning requirements. The measurement gap configuration is known and configured in the UE ΔT before the start of T2. The test parameters are as given in Tables 1-4 below.

TABLE 1
General test parameters for E-UTRAN FDD-FDD inter-frequency RSTD
measurement reporting delay under fading propagation conditions

| Parameter | Unit | Value | Comment |
|---|---|---|---|
| Reference cell | | Cell 1 | Reference cell on RF |
| | | | channel 2 is the cell with |
| | | | respect to which the RSTD |
| | | | measurement is defined, as |
| | | | specified in 3GPP TS |
| | | | 36.214 [4] and 3GPP TS |
| | | | 36.355 [24]. |
| Neighbor cells | | Cell 2 and Cell 3 | Cells on RF channel 2. The |
| | | | cells appear at random |
| | | | places in the neighbour cell |
| | | | list in the OTDOA |
| | | | assistance data, but Cell 2 |
| | | | always appears in the first |
| | | | half of the list, whilst Cell |
| | | | 3 appears in the second half |
| | | | of the list. |
| Serving cell | | Cell 4 | Cell on RF channel 1 |
| PCFICH/PDCCH/PHICH | | DL Reference Measurement | As specified in section |
| parameters | | Channel R.6 FDD | A.3.1.2.1 |
| Channel Bandwidth | MHz | 10 | |
| (BW_{channel}) | | | |
| PRS Transmission | RB | 50 | PRS are transmitted over |
| Bandwidth | | | the system bandwidth |
| Gap pattern Id | | 0 | As specified in Table |
| | | | 8.1.2.1-1. Applies for |
| | | | measurements on Cell 1, |
| | | | Cell 2 and Cell 3 |
| Gap offset | | 25 | As specified in 36.331 [2], |
| | | | Section 6.3.5 |
| PRS configuration | | Cell 1, Cell 2, Cell 3: 1131, | The parameter is as defined |
| index I_{PRS} | | Cell 4: 11 | in 3GPP TS 36.211 [16], |
| | | | Table 6.10.4.3-1 |
| Number of | | 1 | As defined in TS 36.211 |
| consecutive downlink | | | [16]. The number of |
| positioning subframes | | | subframes in a positioning |
| N_{PRS} | | | occasion. Applies for all |
| | | | cells. |
| Physical cell ID PCI | | (PCI of Cell 1-PCI of Cell | The cell PCIs are selected |
| | | 2)mod6 = 0 | such that the relative shifts |
| | | and | of PRS patterns among |
| | | (PCI of Cell 1-PCI of Cell | cells are as given by the |
| | | 3)mod6 = 0 | test parameters |
| | | and | |
| | | (PCI of Cell 1-PCI of Cell | |
| | | 4)mod6 = 1 | |
| CP length | | Normal | |
| DRX | | ON | DRX parameters are |
| | | | specified in Table 3. The |
| | | | UE is in DRX only during |
| | | | T2 and T3. |
| PRS subframe offset | | 0 | Number of subframes |
| | | | rounded to the closest |
| | | | integer. The corresponding |
| | | | parameter in the OTDOA |
| | | | assistance data is prs- |
| | | | SubframeOffset specified |
| | | | in TS 36.355 [24]. Applies |
| | | | for cells in the assistance |
| | | | data only. |
| Subframe offset from | | 17 | Number of full subframes |
| SFN0 of Cell 4 to | | | |
| SFN0 of Cell 1 | | | |
| Subframe shift from a | μs | 10 | The total shift seen at the |
| subframe of Cell 4 to | | | UE antenna connector is 17 |
| the beginning of the | | | subframes and 10 μs |
| next closest subframe | | | |
| of Cell 1 | | | |
| Maximum subframe | μs | 3 | |
| shift between the cells | | | |
| on RF channel 2 at | | | |
| the UE antenna | | | |
| connector^{Note 1} | | | |
| Expected RSTD^{Note 1} | μs | 3 | The expected RSTD is |
| | | | what is expected at the |
| | | | receiver. The |
| | | | corresponding parameter in |
| | | | the OTDOA assistance data |
| | | | specified in TS 36.355 [24] |
| | | | is the expectedRSTD |
| | | | indicator |
| Expected RSTD | μs | 5 | The corresponding |
| uncertainty | | | parameter in the OTDOA |
| | | | assistance data specified in |
| | | | TS 36.355 [24] is the |
| | | | expectedRSTD-Uncertainty |
| | | | index |
| Total number of cells | | 16 | The list comprises 16 cells, |
| provided in OTDOA | | | all on RF channel 2 , |
| assistance data | | | including Cell 1, Cell 2 and |
| | | | Cell 3. |
| PRS muting info | | Cell 1: ‘1111111100000000’ | Correponds to prs- |
| | | Cell 2: ‘0000000011111111’ | MutingInfo defined in TS |
| | | Cell 3: ‘1111111100000000’ | 36.355 [24] |
| T1 | s | 10 | The length of the time |
| | | | interval from the beginning |
| | | | of each test |
| T2 | s | 10 | The length of the time |
| | | | interval that follows |
| | | | immediately after time |
| | | | interval T1 |
| T3 | s | 10 | The length of the time |
| | | | interval that follows |
| | | | immediately after time |
| | | | interval T2 |

^{Note 1}The expected RSTD shall be in accordance with the true time difference modelled in the test at the UE receiver, i.e. the receive time difference for each two cells as seen at the UE antenna connector is within Expected RSTD uncertainty window centered at Expected RSTD, after subtracting the PRS subframe offset, and it shall be different for Cell 2 and Cell 3.

TABLE 2
Cell-specific test parameters for E-UTRAN FDD-FDD inter-frequency RSTD
measurement reporting delay under fading propagation conditions during T1

| Parameter | Unit | Cell 1^{Note 4} | Cell 2 | Cell 3 | Cell 4 |
|---|---|---|---|---|---|
| E-UTRA RF | | 2 | N/A | N/A | 1 |
| Channel | | | | | |
| Number | | | | | |
| OCNG patterns | | OP.2 FDD | N/A | N/A | OP.1 FDD |
| defined in | | | | | |
| A.3.2.1 | | | | | |
| PBCH_RA | dB | 0 | N/A | N/A | 0 |
| PBCH_RB | | | | | |
| PSS_RA | | | | | |
| SSS_RA | | | | | |
| PCFICH_RB | | | | | |
| PHICH_RA | | | | | |
| PHICH_RB | | | | | |
| PDCCH_RA | | | | | |
| PDCCH_RB | | | | | |
| OCNG_RA^{Note 1} | | | | | |
| OCNG_RB^{Note 1} | | | | | |
| N_{oc}^{Note 3} | dBm/15 kHz | −98 | N/A | N/A | −95 |
| PRS Êₛ/N_{oc} | dB | −Infinity | −Infinity | −Infinity | −Infinity |
| Io | dBm/9 MHz | −69.94 | N/A | N/A | −64.21 |
| Êₛ/N_{oc} | dB | −4 | −Infinity | −Infinity | 0 |
| RSRP | dBm/15 kHz | −102 | N/A | N/A | −95 |

| | | |
|---|---|---|
| Propagation Condition | ETU30 | AWGN |

^{Note 1}OCNG shall be used such that the active cells (Cell 1 and Cell 4) are fully allocated and a constant total transmitted power spectral density is achieved for all OFDM symbols.
^{Note 2}The resources for uplink transmission are assigned to the UE prior to the start of time period T2.
^{Note 3}Interference from other cells and noise sources not specified in the test are assumed to be constant over subcarriers and time and shall be modelled as AWGN of appropriate power for N_{oc} to be fulfilled.
^{Note 4}The Cell 1 parameters apply only ΔT ms before T2 starts; no signals are transmitted when the cell is not active.

TABLE 3
Cell-specific test parameters for E-UTRAN FDD-FDD inter-frequency RSTD
measurement reporting delay under fading propagation conditions during T2 and T3

| | | Cell 1 | | Cell 2 | | Cell 3 | | Cell 4 | |
|---|---|---|---|---|---|---|---|---|---|
| Parameter | Unit | T2 | T3 | T2 | T3 | T2 | T3 | T2 | T3 |

| E-UTRA RF | | 2 | | 2 | | 2 | N/A | 1 |
|---|---|---|---|---|---|---|---|---|
| Channel | | | | | | | | |
| Number | | | | | | | | |
| OCNG | | OP.2 FDD | | OP.2 FDD | | OP.2 | N/A | OP.1 |
| patterns | | | | | | FDD | | FDD |
| defined in | | | | | | | | |
| A.3.2.1 | | | | | | | | |
| PBCH_RA | dB | 0 | | 0 | | 0 | N/A | 0 |
| PBCH_RB | | | | | | | | |
| PSS_RA | | | | | | | | |
| SSS_RA | | | | | | | | |
| PCFICH_RB | | | | | | | | |
| PHICH_RA | | | | | | | | |
| PHICH_RB | | | | | | | | |
| PDCCH_RA | | | | | | | | |
| PDCCH_RB | | | | | | | | |
| OCNG_RA^{Note 1} | | | | | | | | |
| OCNG_RB^{Note 1} | | | | | | | | |
| PRS_RA | dB | 0 | N/A | N/A | 0 | 0 | N/A | 0 |
| N_{oc}^{Note 3,4} | dBm/ | −98 | −95 | −98 | −95 | −98 | N/A | −98 |
| | 15 kHz | | | | | | | |
| PRS Êₛ/N_{oc}^{Note 4} | dB | −4 | −Infinity | −Infinity | −10 | −10 | −Infinity | −4 |
| PRS Êₛ/Nₒₜ^{Note 4} | dB | −4.41 | −Infinity | −Infinity | −10 | −11.46 | −Infinity | −4 |
| Io^{Note 4} | dBm/ | −69.87 | N/A | N/A | −67.15 | −69.87 | N/A | −69.94 |
| | 9 MHz | | | | | | | |
| PRP^{Note 4} | dBm/ | −102 | −Infinity | −Infinity | −105 | −108 | −Infinity | −102 |
| | 15 kHz | | | | | | | |
| RSRP | dBm/ | −102 | −102 | −105 | −105 | −108 | −Infinity | −102 |
| | 15 kHz | | | | | | | |

| | | |
|---|---|---|
| Propagation | ETU30 | AWGN |
| Condition | | |

^{Note 1}OCNG shall be used such that active cells (all, except Cell 3 in T3) are fully allocated and a constant total transmitted power spectral density is achieved for all OFDM symbols other than those in the subframes with transmitted PRS. There is no PDSCH allocated in the subframes with transmitted PRS.
^{Note 2}The resources for uplink transmission are assigned to the UE prior to the start of time period T2.
^{Note 3}Interference from other cells and noise sources not specified in the test are assumed to be constant over subcarriers and time and shall be modelled as AWGN of appropriate power for N_{oc} to be fulfilled.
^{Note 4}PRS Êₛ/Iₒₜ, Io, and PRP levels have been derived from other parameters and are given for information purpose. These are not settable test parameters. Interference conditions shall be applied to all PRS symbols of DL positioning subframes.

TABLE 4
DRX parameters for the test of E-UTRAN FDD-FDD inter-frequency
RSTD measurement reporting delay under fading propagation conditions

| Field | Value | Comment |
|---|---|---|
| onDurationTimer | psf1 | As specified in 3GPP |
| Drx-InactivityTimer | psf1 | TS 36.331 [2], Section |
| drx-RetransmissionTimer | sf1 | 6.3.2 |
| longDRX-CycleStartOffset | sf320 | |
| shortDRX | Disable | |

According to an embodiment, the activity information may be used for AECID and fingerprinting positioning. Fingerprinting positioning, generally, uses maps of cellular radio conditions experienced by terminals. By measurement of the radio conditions, the maps are used to find the position of the terminal that fits the measured radio conditions the best. Some systems use a surveyed fine grid of positions to generate the maps. In such systems, the radio conditions in all grid points are then obtained by reference measurements collected by extensive surveying or by advanced prediction software. Other systems use A-GPS position measurements of opportunity, tagged with radio conditions measured by the cellular system in normal operation. The tagged A-GPS positions are then stored in clusters, where the measurements of a cluster all have the same tag (or fingerprint). The result is a self-learning positioning system which is robust to errors due to handheld terminal orientation which significantly affects the antenna diagram in practice.

Other than methods that have been described already, e.g., response time estimation, other non-limiting, example methods of using the activity information for AECID and fingerprinting are described below. One such example is using the UE activity information for tagging other positioning or RF measurements, e.g., for AECID or fingerprinting positioning, e.g., not only the measurement time, but also the measurement quality may be impacted by the activity state in which the measurements are performed. Iit is therefore proposed that measurements used for fingerprinting and AECID are tagged with the UE activity information which may be utilized, e.g., for building separate clusters for different states. The described tagging may also be useful as an indication about the measurement period and the measurement sampling rate. For example, the reported measurements for fast moving UEs which are performed while in a long DRX state, may reflect the true environment with a larger error due to fewer samples and because the UE in a long DRX might move farther away as compared with the UE which is in a non-DRX state since the beginning of measurements. Measurements associated with periods of higher inactivity may thus be avoided, i.e., not performed, or alternatively such measurements may be assigned a lower weight for positioning that requires high confidence, e.g., E911 positioning. According to the embodiments described above, the activity information may also be used for estimating the quality of measurements of reported measurements, e.g., the standard deviation of the reported measurements, since it may indicate the number of samples taken between reports as such quality information is typically valuable in position calculation.

Another example is using the UE activity information as a fingerprint or a “measurement” for AECID or fingerprinting and maintaining the UE activity information in AECID or fingerprinting databases, e.g., in the same environment, different UEs may have similar behavior and similar activity states, which may be a useful information for defining the UE position. For example, in heterogeneous deployments, certain restricted measurement patterns may indicate specific geographical areas; the activity information may thus be stored as any other measurement in AECID or fingerprinting databases.

The afore-described exemplary embodiments provide, among other advantages for:
Enabling the activity information in the positioning node;
Enhanced determination of the estimated response time for a positioning method;
Enhanced positioning method selection;
Enhanced positioning quality, compliant with the positioning measurement requirements;
Enhanced fingerprinting and AECID positioning methods with the activity information; and/or
Enabling using the activity information for testing positioning performance, e.g., to determine when the UE is can start positioning measurements.

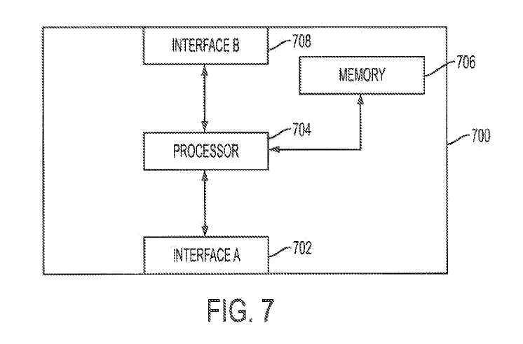

The foregoing methods can be embodied in nodes or structures which are configured to perform the steps described in the above embodiments. An exemplary positioning node, eNodeB, UE or other node 700 described above is generically illustrated in FIG. 7. If the node 700 includes air interface capability, e.g., if node 700 is a UE or eNodeB, then the node 700 includes an air interface 702, e.g., a radio transceiver, connected to one or more antennas. The interface 702 is connected to processor(s) 704, which is configured to analyze and process signals received over the air interface 702. The processor(s) 704 may also be connected to one or more memory device(s) 706. Further units or functions, not shown, for performing various operations as encoding, decoding, modulation, demodulation, encryption, scrambling, precoding, etc. may optionally be implemented not only as electrical components but also in software or a combination of these two possibilities as would be appreciated by those skilled in the art to enable the interface 702 and processor(s) 704 to process uplink and downlink signals.

When operating as an eNodeB, node 700 can have other interfaces, e.g., interface 708 with which to communicate with a core network or other eNodeBs. When operating as, for example, a positioning node, the transceiver can be omitted (unless, e.g., the positioning node is implemented as part of a node that needs air interface capabilities) and other appropriate interfaces substituted therefore to enable standardized communications and signals to be transmitted which are configured to perform the afore-described positioning related functions.

For example, the network node 700 can thus include a processor 704 configured to obtain user equipment, UE, activity information, wherein the UE activity information is associated with at least one of transmission activity and reception activity for a UE, and to adapt a positioning function using the UE activity information.

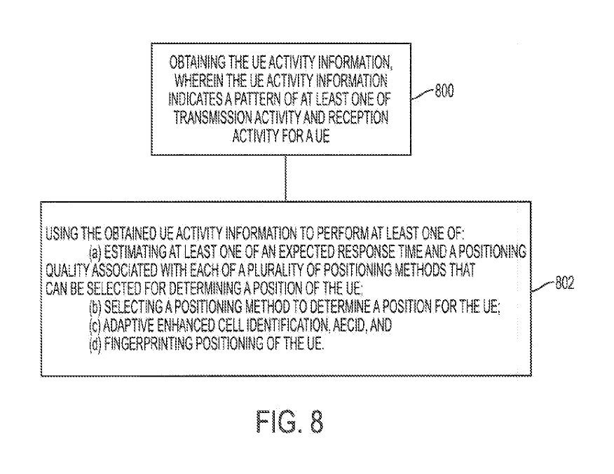

Thus, according to one embodiment, a method for using user equipment, UE, activity information by a network node in a communications network can include the steps illustrated in the flowchart of FIG. 8. Therein, a network node can obtain the UE activity information, e.g., in any of the afore-described ways, wherein the UE activity information is associated with at least one of transmission activity and reception activity for a UE, as shown by step 800. The network node can then configure a positioning function using the UE activity information as indicated by step 802.

According to another embodiment, a method for positioning of a user equipment (UE) comprises: determining UE activity associated with the UE, and using said determined UE activity to determine a position of the user equipment.

According to an embodiment, a method for positioning of a user equipment (UE) comprises: determining UE activity associated with the UE, and selecting a positioning technique to be used to determine a position of said UE based on said UE activity.

According to an embodiment a method for positioning of a user equipment (UE) comprises: receiving UE activity information and using said received UE activity information to determine a position of the user equipment.

According to an embodiment, a method for positioning of a user equipment (UE) comprises: receiving UE activity information and selecting a positioning technique to be used to determine a position of said UE based on said UE activity.

According to an embodiment, a method for positioning of a user equipment (UE) comprises: obtaining UE activity information and estimating an expected response time associated with a positioning method based on the UE activity information.

According to an embodiment, a method for positioning of a user equipment (UE) comprises: obtaining UE activity information and using the UE activity information in AECID or fingerprinting.

According to embodiments, each of the afore-described methods can be performed in a device, system or node which includes a processor configured to perform the functions stated in the method.

### Inter-Frequency Scenarios for RSTD Measurements

Embodiments described above can also be applied to inter-frequency RSTD requirements, which requirements are defined for the following two scenarios in the standards document 3GPP TS 36.133, “Evolved Universal Terrestrial Radio Access (E-UTRA); Requirements for support of radio resource management”.

Scenario 1: Inter-frequency RSTD measurements are performed for the reference cell and neighbour cells, where all cells belong to the inter-frequency carrier frequency f2 which is different from the serving cell E-UTRAN frequency f1.

Scenario 2: Inter-frequency RSTD measurements are performed over the reference cell and the neighbour cells, which belong to the serving FDD carrier frequency f1 and the FDD inter-frequency carrier frequency f2, respectively.

The RSTD accuracy requirements are exactly the same for both of these scenarios, whilst the reporting delay requirements differ, with the maximum RSTD reporting delay being longer for Scenario 2. To minimize the number of test cases, it has been proposed in to develop inter-frequency test cases only for Scenario 2 since measuring all cells on the same frequency, even being different from the serving-cell frequency, is less challenging than measuring two cells on different frequencies. However, if both scenarios have practical application, it is best to test the requirements for both scenarios to ensure that the required quality of positioning measurements is met in practice. Accordingly, other embodiments propose testing for both scenarios as will now be described below, after describing the test scenarios themselves in more detail.

Scenario 1

Scenario 1 targets the following example use cases,

deployments with PRS transmitted on one frequency, but not configured on the other frequency, or

deployments with the sufficient number of hearable cells and the minimum required signal quality in co-channel operation, including deployments with base stations of different power classes, or

deployments with a larger PRS transmission bandwidth on one carrier which may make positioning measurements on that carrier more attractive, or

handover areas where the serving cell has changed but RSTD measurements continue.

In a general case, even though having the reference cell on a non-serving carrier may be less common, the use cases above are also important and thus the proper positioning performance for Scenario 1 has to be ensured as well.

Scenario 2

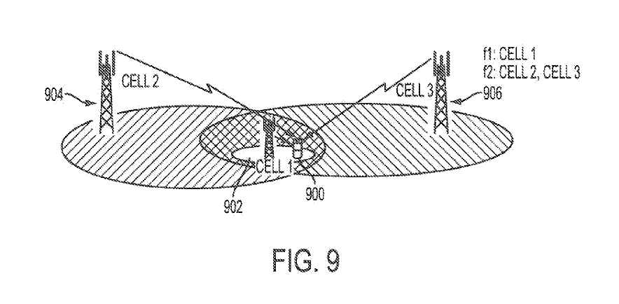

Scenario 2 is illustrated in FIG. 9 with a UE 900 locating in overlapping coverage areas associated with low power node (Cell 1) 902, high(er) power node (Cell 2) 904 and high(er) power node (Cell3) 906. One typical use case for this scenario may occur, for example, in heterogeneous network deployments with lower-power nodes operating on a separate carrier, where these nodes, however, do not have continuous coverage over the network area or have a strong interferer nearby and thus the sufficient number of neighbour cells with good distinct locations for OTDOA cannot be detected on this carrier. On the other hand, having such a node as a reference cell may be desirable due to the good signal quality.

Another practical example of Scenario 2 is explained next. In practice it may also be so that neither the number of hearable cells on f2 nor the number of hearable cells on f1 are sufficient, e.g., in urban canyons or indoors. Note also that since relative locations of base stations are not always optimal for individual UEs and the signal strengths may vary a lot, RSTD measurements from more than 3 cells are typically needed in practice to ensure good positioning performance. The assistance data may thus contain cells on the serving-cell frequency and cells on another frequency, with the reference cell on a serving carrier, which will enable parallel intra-frequency measurements and inter-frequency measurements of Scenario 2.

Having described the testing scenarios in further detail some exemplary test configurations and their associated requirements according to embodiments will now be described.

### Scenario 1

Test setup. The setup of inter-frequency test cases for Scenario 1 distinguishes from intra-frequency test cases in that all cells included in the assistance data operate on an RF channel f2 different from the serving cell RF channel f1. Since none of the measured and thus explicitly modeled cells is the serving cell, the serving cell needs to be also added in the test, i.e., the RSTD accuracy test environment for Scenario 1 comprises three modeled cells, and the RSTD reporting delay test environment for Scenario 1 comprises four modeled cells. Four cells are also used for protocol testing, but to simplify testing it is proposed that in the four-cell test cases the fast fading is not modeled for the serving cell. The following cell arrangement for inter-frequency RSTD reporting delay tests is proposed:

Cell 1—reference cell on f2, ETU30,

Cell 2, Cell 3—neighbour cells on f2, ETU30,

Cell 4—serving cell on f1, AWGN.

For inter-frequency RSTD measurement accuracy test cases in Scenario 1, three cells (e.g., Cell 1, Cell 2 and Cell 4 from the list above) are necessary.

Considering now RSTD reporting delay requirements, according to the standard with a positioning subframe configuration period equal to 1280 ms, the OTDOA measurements have to be reported after at most M=8 positioning occasions with the specified interference conditions being met for all subframes of at least

$$L = \frac{M}{2}$$

positioning occasions. The RSTD measurement reporting delay in these test cases is derived from the following expression:

$${T}_{PRS} ( M - 1 ) + 160 ⌈ \frac{n}{M} ⌉$$

where M=8 and n=16 are the parameters specified in the standard. This gives the total RSTD reporting delay of 9280 ms for Cell 2 and Cell 3 with respect to the reference cell Cell 1.

Reference timing. The UE typically knows the SFN of the serving cell, which is included in the assistance data in Scenario 2 but not in Scenario 1. The UE generally does not read the system information of neighbour cells which has to be done before the measurements in the time interval T2 can start. This requires a slightly longer time after the UE receives the assistance data and starts measurements to allow for acquiring the timing information of the reference cell. However, considering that DRX is used in the test, it is also not very clear from the OTDOA requirements whether the UE should use non-DRX after receiving the assistance data to acquire the timing information of the reference cell or in the beginning of the RSTD measurement period which is subject to the RSTD requirements. We prefer that the UE is initially in DRX; after the timing information of the reference cell is available, the UE switches to DRX and stays in DRX during T1, T2, and T3. Otherwise, if DRX is 2560 ms, then the cell search can be as long as 51.2 seconds.

Measurement gap configuration. Measurement gaps are necessary for UEs that are not able to perform inter-frequency measurements without gaps. Therefore, in the test cases, measurement gaps are configured to enable inter-frequency RSTD measurements on Cell 2 and Cell 3. Furthermore, gap pattern configuration #0 shall be used according to the requirement in 3GPP TS 36.133, “Evolved Universal Terrestrial Radio Access (E-UTRA); Requirements for support of radio resource management”. Following also the inter-frequency requirement in 3GPP TS 36.133, the measurement gaps and positioning occasions are configured in a way so that there are no measurement gaps overlapping with the PRS subframes in the serving carrier. In Scenario 1, the serving cell is not measured for positioning; however, it is still proposed that PRS are configured in the serving cell to test the UE in conditions with shifted PRS positioning occasions in the two frequencies, as required by the standard.

PRS configuration. Similar to the intra-frequency case, PRS muting in half of positioning occasions is used to model L positioning occasions where the core requirement side conditions, i.e. the received signal strength and the received signal quality, are met. The test consists of three consecutive time intervals, with duration of T1, T2 and T3. Cell 1 and Cell 4 are active in T1, T2 and T3, whilst Cell 2 and Cell 3 are activated only in the beginning of T2. Cell 2 is active until the end of T3, and Cell 3 is active until the end of T2. Further, Cell 1 and Cell 3 transmit PRS only in T2. Cell 2 transmits PRS only in T3. Cell 4 transmits PRS in T2 and T3.

Scenario 2

Test setup. The setup of inter-frequency test cases for Scenario 2 is similar to that for intra-frequency test cases, with the main difference that all cells included in the assistance data but the reference cell (being also the serving cell) operate on RF channel f2 different from the serving-cell RF channel f1. Three cells are to be explicitly modeled in the inter-frequency RSTD reporting delay tests for Scenario 2:

Cell 1—reference (also serving) cell on f1, ETU30,

Cell 2, Cell 3—neighbour cells on f2, ETU30.

For inter-frequency RSTD measurement accuracy test cases in Scenario 2, two cells (Cell 1 and Cell 2 from the list above) are necessary.

RSTD reporting delay requirement. According to Table 8.1.2.6.1-1 and Table 8.1.2.6.3-1 under Note 2, with positioning subframe configuration period=1280 ms, the OTDOA measurements have to be reported after at most M=16 positioning occasions with the specified interference conditions being met for all subframes of at least

$$L = \frac{M}{2}$$

positioning occasions. The RSTD measurement reporting delay in these test cases is derived from the following expression:

$$, {T}_{PRS} ( M - 1 ) + 160 ⌈ \frac{n}{M} ⌉$$

where M=16 and n=16 are the parameters specified in the standard. This gives the total RSTD reporting delay of 19360 ms for Cell 2 and Cell 3 with respect to the reference cell Cell 1.

Measurement gap configuration. Measurement gap pattern #0 is configured and the measurement gaps are configured to avoid collision with PRS in the serving cell. PRS configuration. Similar to the intra-frequency case, PRS muting in half of positioning occasions is used to model L positioning occasions where the core requirement side conditions, i.e. the received signal strength and the received signal quality, are met. The test consists of three consecutive time intervals, with duration of T1, T2 and T3. The cell activity is as in intra-frequency test cases: Cell 1 is active in T1, T2 and T3, Cell 2 is active in T2 and T3, and Cell 3 is active in T3. Further, Cell 1 and Cell 3 transmit PRS in T2, whilst Cell 2 transmits PRS in T3.

The above-described embodiments are intended to be illustrative in all respects, rather than restrictive, of the present invention. All such variations and modifications are considered to be within the scope and spirit of the present invention. No element, act, or instruction used in the description of the present application should be construed as critical or essential to the invention unless explicitly described as such. Also, as used herein, the article “a” is intended to include one or more items.

1. A method for using user equipment, UE, activity information by a network node in a communications network, the method comprising:
obtaining the UE activity information, wherein the UE activity information indicates a pattern of at least one of transmission activity and reception activity for a UE, and
using the obtained UE activity information to perform at least one of:
estimating at least one of an expected response time and a positioning quality associated with each of a plurality of positioning methods that can be selected for determining a position of the UE;
selecting a positioning method to determine a position for the UE;
adaptive enhanced cell identification, AECID, and
fingerprinting positioning of the UE.

2. The method of claim 1, wherein the step of obtaining the UE activity information further comprises:
autonomously determining, by the network node, the UE activity information based on information available in the communications network.

3. The method of claim 2, further comprising:
receiving, as said information, measurement reports from which the UE activity information can be determined, which measurement reports may be periodic or event-triggered, wherein a reporting interval associated with the measurement reports is used to determine the UE activity information.

4. The method of claim 3, further comprising:
maintaining, by the network node, predetermined information associated with expected UE reporting rates in different activity states; and
determining the UE activity information for the UE by comparing a UE reporting rate and the predetermined information associated with expected UE reporting rates for different activity states to select one of the different activity states as the UE activity information.

5. The method of claim 2, further comprising:
collecting measurement statistics for the UE; and
determining the UE activity information by comparing the measurement statistics for the UE with a reporting frequency of the UE at different time intervals.

6. The method of claim 2, further comprising:
collecting measurement statistics and positioning results for a plurality of UEs; and
determining the UE activity information based on both the collected measurement statistics and positioning results for the plurality of UEs.

7. The method of claim 1, wherein the step of obtaining the UE activity information further comprises:
receiving the UE activity information from at least one of the UE and another network node.

8. The method of claim 7, wherein the another network node is one of:
a positioning node;
a network node which has positioning functionality;
a positioning platform in a user plane such as a secure user plane location, SUPL, a location platform, SLP, in a long term evolution, LTE, network;
a positioning node in a control plane such as an enhanced serving mobile location center, E-SMLC, in an LTE network; and
a radio network node such as an eNode B or a radio measurement unit; and
a network node such as SON or MDT.

9. The method of claim 1 above wherein the network node is a positioning node such as an E-SMLC in LTE.

10. The method of claim 1, wherein the UE activity information includes one or more of:
a discontinuous reception, DRX, and/or discontinuous transmission DTX indication;
a DRX and/or DTX configuration;
a type of duplex mode of operation;
an uplink, UL, and/or downlink, DL, and special subframe configurations for time division duplex operation;
minimum UL and DL subframes in a frame for half duplex frequency division duplex operation;
a restricted measurement configuration;
a UE transmitting/receiving pattern over multiple carriers in a multi-carrier system;
a pattern describing periodicity and/or allocations of UE transmission and/or receiving activity;
a portion of time spent by the UE in an activity or inactivity state(s) during a positioning session; and
a measurement cycle used for performing measurement on secondary cells in carrier aggregation.

11. The method of claim 1, wherein the UE activity information indicates at least one mode of transmit and/or receive operation which governs UE's usage of transmit and/or receive air interface resources.

12. The method of claim 1, wherein using the obtained UE activity information further comprises:
estimating an expected response time of at least one of a plurality of positioning methods in order to determine a respective length of a positioning session for the UE using each of the plurality of positioning methods.

13. The method of claim 12, wherein the estimated length of the positioning session is used by the network node to perform at least one of:
reserving positioning resources, stopping the positioning session, delaying handover of the UE, deciding on a position session organization such as number of parallel measurements to be performed, and estimating an impact on battery lifetime.

14. The method of claim 1, wherein using the obtained UE activity information further comprises:
estimating at least one of positioning measurement quality characteristic and position quality of at least one from a plurality of positioning methods.

15. The method of claim 13, wherein using the obtained UE activity information further comprises:
comparing the at least one of the estimated positioning measurement quality characteristic and position quality for the at least one of the plurality of positioning methods; and
selecting one of the plurality of positioning methods for use in determining a position of the UE based on the comparing.

16. The method of claim 1, wherein using the obtained UE activity information further comprises:
selecting a positioning method using the obtained UE activity information by determining at least one of: (a) measurement quality characteristic, (b) position quality of the positioning method, and (c) positioning response time of the positioning method.

17. The method of claim 16 wherein the step of determining further comprises estimating the at least one of: (a) measurement quality characteristic, (b) position quality of the positioning method, and (c) positioning response time of the positioning method for a given UE based on collected statistics.

18. The method of claim 16, further comprising:
determining, when discontinuous reception, DRX, is used for the UE, a measurement delay based on a length of a DRX cycle for both observed time difference of arrival, OTDOA, and enhanced cell identification, E-CID, positioning methods; and
selecting one of OTDOA and E-CID which has at least one of (a) a smaller measurement delay, (b) a smaller positioning response time of the positioning method, (c) better positioning measurement quality, and (d) better position quality to use to perform positioning for the UE

19. The method of claim 1, wherein using the obtained UE activity information further comprises:
using the obtained UE activity information for at least one of enhanced cell identification (E-CID), adaptive enhanced cell identification, AECID, fingerprinting positioning of the UE, OTDOA, UTDOA or an uplink positioning method.

20. The method of claim 19, further comprising:
tagging measurements taken for the at least one of enhanced cell identification (E-CID), adaptive enhanced cell identification, AECID, fingerprinting of the UE, OTDOA, UTDOA or an uplink positioning method with the UE activity information.

21. The method of claim 20, further comprising:
excluding, or using with a lower weight, tagged measurements associated with a higher UE inactivity for a positioning function that requires positioning accuracy above a certain threshold accuracy.

22. The method of claim 1, wherein using the obtained UE activity information further comprises:
configuring the network node with at least one predetermined positioning method for the network node; and
selecting the at least one predetermined positioning method for the network node based upon the obtained UE activity information.

23. The method of claim 22, wherein the at least one predetermined positioning method for the network node is a prioritized sequence of positioning methods for the network node to use based on an activity state of the UE.

24. The method of claim 1, wherein using the obtained UE activity information further comprises:
using the obtained UE activity information to determine the amount of time required (Δt) by the UE for acquiring reference cell timing; and
sending OTDOA assistance data at least At duration prior to a time when a UE can start performing RSTD measurements of the requested cells.

25. The method of claim 24, wherein the step of sending OTDOA assistance data further comprises:
sending the OTDOA assistance data at least Δt+T₀ duration prior to the time when the UE is able to complete the RSTD measurements of the requested cells; wherein T0 is the time required by the UE to measure RSTD of cells when reference cell timing is known.

26. The method of claim 24, wherein the duration (Δt) comprises at least a time required by the UE to search or identify a reference cell.

27. The method of claim 26, wherein the duration (Δt) further comprises a time required by the UE to read system information of a reference cell for acquiring the system frame number.

28. The method of claim 24 wherein the UE activity information is a DRX cycle used by the UE.

29. The method of claim 24, further comprising:
wherein the network node is a test equipment or a system simulator emulating a positioning node.

30. The method of claim 24, further comprising:
wherein the network node is a positioning node such as E-SMLC in LTE

31. The method of claim 1, wherein using the obtained UE activity information further comprises:
selecting, using the UE activity level information, one or more parameters which are used in a positioning method.

32. A network node comprising:
a processor configured to obtain user equipment, UE, activity information, wherein the UE activity information is associated with at least one of transmission activity and reception activity for a UE, and configured to use the obtained UE activity information to perform at least one of:
estimating at least one of an expected response time and a positioning quality associated with each of a plurality of positioning methods that can be selected for determining a position of the UE;
selecting a positioning method to determine a position for the UE;
adaptive enhanced cell identification, AECID; and
fingerprinting positioning of the UE.

33. The network node of claim 32, wherein the processor is further configured to obtain the UE activity information by autonomously determining the UE activity information based on information available in a communications network.

34. The network node of claim 33, further comprising:
an interface configured to receive, as said information, measurement reports from which the UE activity information can be determined, which measurement reports may be periodic or event-triggered, wherein a reporting interval associated with the measurement reports is used to determine the UE activity information.

35. The network node of claim 34, further comprising:
a memory unit configured to maintain predetermined information associated with expected UE reporting rates in different activity states; and
wherein the processor is further configured to determine the UE activity information by comparing a UE reporting rate and the predetermined information associated with expected UE reporting rates for different activity states to select one of the different activity states as the UE activity information.

36. The network node of claim 35, wherein the processor is further configured to collect measurement statistics for the UE, and to determine the UE activity information by comparing the measurement statistics for the UE with a reporting frequency of the UE at different time intervals.

37. The network node of claim 33, wherein the processor is further configured to collect measurement statistics and positioning results for a plurality of UEs; and to determine the UE activity information based on both the collected measurement statistics and positioning results for the plurality of UEs.

38. The network node of claim 32, wherein the processor is configured to obtain the UE activity information by receiving the UE activity information from at least one of the UE and another network node.

39. The network node of claim 38, wherein the another network node is one of:
a positioning node;
a network node which has positioning functionality;
a positioning platform in a user plane such as a secure user plane location, SUPL, a location platform, SLP, in a long term evolution, LTE, network;
a positioning node in a control plane such as an enhanced serving mobile location center, E-SMLC, in an LTE network, a radio network node such as an eNode B or a radio measurement unit; and
a network node such as a SON or MDT.

40. The network node of claim 32 above wherein the network node is a positioning node such as an E-SMLC in LTE.

41. The network node of claim 32, wherein the UE activity information includes one or more of:
a discontinuous reception, DRX, and/or discontinuous transmission DTX indication;
a DRX and/or DTX configuration;
a type of duplex mode of operation;
an uplink, UL, and/or downlink, DL, and special subframe configurations for time division duplex operation;
minimum UL and DL subframes in a frame for half duplex frequency division duplex operation;
a restricted measurement configuration;
a UE transmitting/receiving pattern over multiple carriers in a multi-carrier system;
a pattern describing periodicity and/or allocations of UE transmission and/or receiving activity;
a portion of time spent by the UE in an activity or inactivity state(s) during a positioning session; and
a measurement cycle used for performing measurement on secondary cells in carrier aggregation.

42. The network node of claim 32, wherein the UE activity information indicates at least one mode of transmit and/or receive operation which governs UE's usage of transmit and/or receive air interface resources.

43. The network node of claim 32, wherein the processor is further configured to use the UE activity information by estimating an expected response time of at least one of a plurality of positioning methods in order to determine a respective length of a positioning session for the UE using each of the plurality of positioning methods.

44. The network node of claim 43, wherein the estimated length of the positioning session is used by the processor to perform at least one of: reserving positioning resources, stopping the positioning session, delaying handover of the UE, deciding on a position session organization such as number of parallel measurements to be performed, and estimating an impact on battery lifetime.

45. The network node of claim 32, wherein the processor is further configured to by estimating at least one of positioning measurement quality characteristic and position quality of at least one from a plurality of positioning methods.

46. The network node of claim 45, the processor is further configured to use the UE activity information by comparing the at least one of the estimated positioning measurement quality characteristic and position quality for the at least one of the plurality of positioning methods; and selecting one of the plurality of positioning methods for use in determining a position of the UE based on the comparing.

47. The network node of claim 32, wherein the processor is further configured to use the UE activity information by selecting a positioning method using the obtained UE activity information by determining at least one of: (a) measurement quality characteristic, (b) position quality of the positioning method, and (c) positioning response time of the positioning method.

48. The network node of claim 47, wherein the processor is further configured to determine the at least one of: (a) measurement quality characteristic, (b) smaller positioning response time, (c) position quality of the positioning method, and (d) positioning response time of the positioning method for a given UE, based on collected statistics.

49. The network node of claim 47, wherein the processor is further configured to determine, when discontinuous reception, DRX, is used for the UE, a measurement delay based on a length of a DRX cycle for both observed time difference of arrival, OTDOA, and enhanced cell identification, E-CID, positioning methods and to select one of OTDOA and E-CID which has at least one of (a) a smaller measurement delay, (b) a better positioning measurement quality, and (c) a better position quality to use to perform positioning for the UE

50. The network node of claim 32, wherein the processor is further configured to use the UE activity information by using the obtained UE activity information for at least one of enhanced cell identification (E-CID), adaptive enhanced cell identification, AECID, fingerprinting positioning of the UE, OTDOA, UTDOA or an uplink positioning method.

51. The network node of claim 50, wherein the processor is further configured to tag measurements taken for at least one of enhanced cell identification (E-CID), adaptive enhanced cell identification, AECID, fingerprinting of the UE, OTDOA, UTDOA or an uplink positioning method with the UE activity information.

52. The network node of claim 32, wherein the processor is further configured to use the UE activity information by configuring the network node with at least one predetermined positioning method for the network node; and selecting the at least one predetermined positioning method for the network node based upon the obtained UE activity information.

53. The network node of claim 52, wherein the at least one predetermined positioning method for the network node is a prioritized sequence of positioning methods for the network node to use based on an activity state of the UE.

54. The network node of claim 32, wherein the processor is further configured to use the UE activity information by using the obtained UE activity information to determine the amount of time required (Δt) by the UE for acquiring reference cell timing, and sending OTDOA assistance data at least Δt duration prior to a time when UE can start performing RSTD measurements of the requested cells

55. The network node of claim 54, wherein the processor is further configured to send the OTDOA assistance data at least Δt+T₀ duration prior to the time when the UE is able to complete the RSTD measurements of the requested cells; wherein T0 is the time required by the UE to measure RSTD of cells when reference cell timing is known.

56. The network node of claim 54, wherein the duration (Δt) comprises at least time required by the UE to search or identify a reference cell.

57. The network node of claim 56, wherein the duration (Δt) further comprises time required by the UE to read the system information of a reference cell for acquiring the system frame number.

58. The network node of claim 54, wherein the UE activity information is the DRX cycle used by the UE.

59. The network node of claim 54, wherein the network node is a test equipment or a system simulator emulating a positioning node.

60. The network node of claim 54, wherein the network node is a positioning node such as E-SMLC in LTE

61. The network node of claim 32, wherein the processor is further configured to use the UE activity information by selecting, using the UE activity level information, one or more parameters which are used in a positioning method.

62. A device comprising:
a transceiver configured to transmit a message which includes information associated with a user equipment's, UE's, activity level, wherein the UE's activity level information indicates a pattern of at least one of transmission and reception activity by the UE.

63. The device of claim 62, wherein the device is the UE.

64. The device of claim 62, wherein the device is a radio node.

65. The device of claim 62, wherein the information associated with the UE's activity level comprises at least one of:
a discontinuous reception, DRX, and/or discontinuous transmission DTX indication;
a DRX and/or DTX configuration;
a type of duplex mode of operation;
an uplink, UL, and/or downlink, DL, and special subframe configurations for time division duplex operation;
minimum UL and DL subframes in a frame for half duplex frequency division duplex operation;
a restricted measurement configuration;
a UE transmitting/receiving pattern over multiple carriers in a multi-carrier system;
a pattern describing periodicity and/or allocations of UE transmission and/or receiving activity;
a portion of time spent by the UE in an activity or inactivity state(s) during a positioning session; and
a measurement cycle used for performing measurement on secondary cells in carrier aggregation.
